(19) United States
(12) Patent Application Publication
(10) Pub. No.: US 2013/0087082 A1
(43) Pub. Date: Apr. 11, 2013

(54) FURNITURE WITH INTEGRATED STORAGE FOR WATER OR OTHER MATERIAL

(71) Applicant: Tonia Walstad Miller, Excelsior, MN (US)

(72) Inventor: Tonia Walstad Miller, Excelsior, MN (US)

(21) Appl. No.: 13/268,083

(22) Filed: Oct. 7, 2011

(51) Int. Cl. A47B 37/00; F21V 33/00; A47C 7/62

(52) U.S. Cl. 108/28; 297/188.01; 362/101

(57) ABSTRACT

Furniture pieces which include integrated storage capacity for storing water or other material. By incorporating such storage capacity within furniture, a user may take advantage of space that would otherwise be unused or unusable to unobtrusively and conveniently store an emergency water supply or other desired material.

### BACKGROUND OF THE INVENTION

Field of the Invention

The present invention relates generally to furniture and, more specifically, to furniture which is capable of storing water or other material within its structure.

Background Information

In preparation for possible emergency situations such as natural disasters, power outages and the like, public safety agencies often recommend that residents keep a supply of potable water stored in a readily accessible location. In an emergency in which a loss of power or contamination renders the normal water supply (municipal or private) unusable, residents who have made such preparations will have sufficient drinking water to sustain them for at least a brief time.

One problem that often arises in connection with creating an emergency water supply of sufficient capacity is inadequate storage space. For example, FEMA recommends storing at least a three-day emergency water supply which includes at least one gallon of water per person per day just for drinking. Following that recommendation with some additional allowance for unforeseen needs, a family of four persons would need to store at least 15 gallons of water. Further, the same family of four would need to store on the order of 35 gallons of water (e.g., 7 five-gallon containers) to be prepared for an emergency lasting about one week. Thus, storage of a reasonable emergency water supply for even a few people quickly translates into significant storage space. In addition, while it is desirable to store an emergency water supply such that is readily accessible, most people will also want to avoid moving heavy containers of water frequently or at all. Also, in order to avoid detracting from the atmosphere and decor of their homes, most people will prefer that their emergency water supplies be stored in a way that is inconspicuous and aesthetically acceptable.

### SUMMARY OF THE INVENTION

In brief summary, the present invention provides a variety of furniture pieces in which water or other material may be stored. The furniture pieces include tables and chairs having hollow, load-bearing bases or frames which are liquid tight and provide integrated storage capacity for water or other material. The bases or frames may be configured for filling from the top or bottom with access provided for drawing water or other material out. The furniture pieces also include a table in which water or other material may be stored in a bladder or other structure which is suspended beneath the tabletop. The furniture pieces further include a lamp having a liquid tight globe and a base which both supports and illuminates the globe.

In some embodiments of the present invention, in order to fill or draw water or other material, a user may simply remove a tabletop, chair seat or other structure and thereby gain access to a port. In alternative embodiments, a pump assembly may be used with the port.

### BRIEF DESCRIPTION OF THE DRAWINGS

The invention description below refers to the accompanying drawings, of which:

FIG. 1 is a side elevation of a bench-type chair having a hollow frame which provides integrated storage capacity for water or other material;

FIG. 2 is a perspective view of a lounge-type chair having a hollow frame which provides integrated storage capacity for water or other material;

FIG. 3 is a perspective view of a lamp having a globe in which water or other material may be stored;

FIGS. 4A and 4B are perspective and top plan views, respectively, of a table having a hollow base which provides integrated storage capacity for water or other material;

FIG. 5 is a perspective view of a pedestal-type chair whose seat structure is hollow and provides integrated storage capacity for water or other material;

FIG. 6 is a perspective view of a footed chair whose seat structure is hollow and provides integrated storage capacity for water or other material;

FIGS. 7A-7F are perspective views of end tables having hollow support structures which provide integrated storage capacity for water or other material;

FIG. 8A is a perspective view of a table having a removable top and a hollow pedestal-type base which provides integrated storage capacity for water or other material;

FIG. 8B is a cross section of the table of FIG. 8A with a pump installed for drawing water or other material from the base;

FIGS. 9A and 9B are side views of a pedestal-type chair whose seat structure and pedestal are hollow and provide integrated storage capacity for water or other material;

FIG. 10A is a perspective view of a table having integrated storage capacity for water or other material;

FIG. 10B is a side elevation of the table shown in FIG. 10A;

FIG. 10C is an enlarged side elevation of a valve shown in FIG. 10B;

FIG. 11A is a side elevation of a chair having integrated storage capacity for water or other material;

FIG. 11B is a top plan view of the chair shown in FIG. 11A with its seat cushion removed; and

FIGS. 12A and 12B are side elevations of a sculpture having integrated storage capacity for water or other material.

### DETAILED DESCRIPTION OF ILLUSTRATIVE EMBODIMENTS

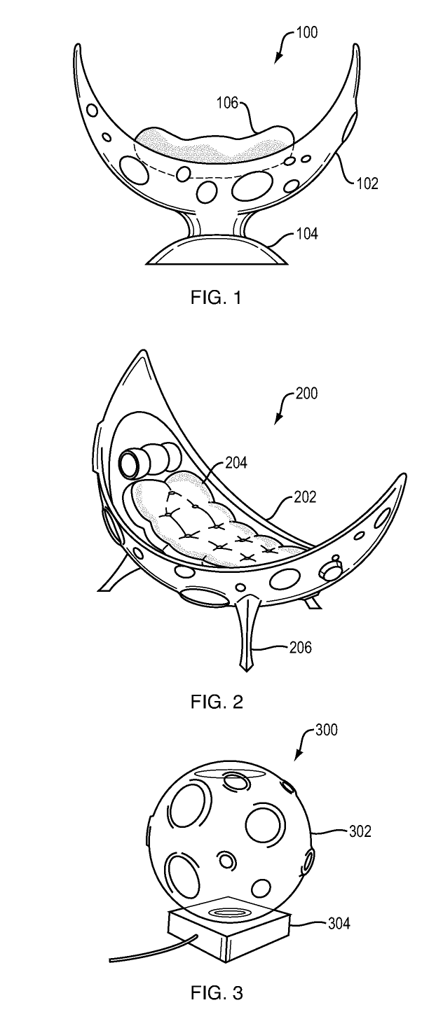

FIG. 1 shows a bench-type chair 100 having a seat 102 supported by a pedestal 104, and a cushion 106. Seat 102 or pedestal 104 or both are preferably substantially hollow and constructed of one or more materials that provide suitable load-bearing strength, are liquid-tight and safe for storing water or other material that is intended for human consumption. Such materials include a wide variety of commercially available plastics which may also serve as the finish surface of chair 100 or may be covered with wood veneer, cloth or other material for decorative purposes.

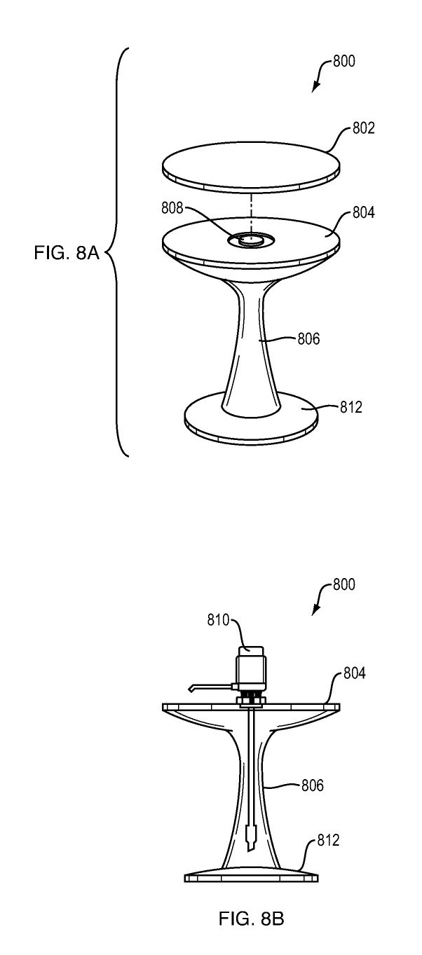

Access for filling chair 100 with water or other material, as well as drawing from the chair, may be provided in a variety of ways. For example, a user access port having a simple screw cap, stopper or other closing mechanism (not shown) may be located at an advantageous position on seat 102. Depending upon the location of the port and weight of chair 100, a user may be able to pour from the port, either by gravity or by tipping the chair, or alternatively may insert a hose (not shown) and siphon from the port. A pump like the one described below in connection with FIG. 8B may be also used to draw water or other liquid from such a port in chair 100. Depending upon the overall dimensions of chair 100 and with consideration to the weight of the chair when it is filled with water or other material, chair 100 provides integrated capacity for storing on the order of at least several gallons of water if not more.

FIG. 2 shows a lounge-type chair 200 having a cushion 204 disposed on a seat 202 supported by legs 206. Seat 202 is preferably substantially hollow and constructed in manner like that described above. Access for filling or drawing from the integrated storage capacity provided by chair 200 may be provided in a manner similar to that described above.

FIG. 3 shows a lamp 300 having globe 302 and a base 304. Globe 302 is preferably constructed of glass, plastic or other material that is liquid-tight and substantially transparent. A screw cap, stopper or other mechanism (not shown) may provide a port on globe 302 for filling or drawing from the globe. A suitable illumination element, such as a fluorescent ring or a group of light-emitting diodes, may be disposed within base 304 and used to illuminate globe 302 from below. Thus, when globe 302 is constructed from a substantially transparent material, filled with water and illuminated from below it should glow.

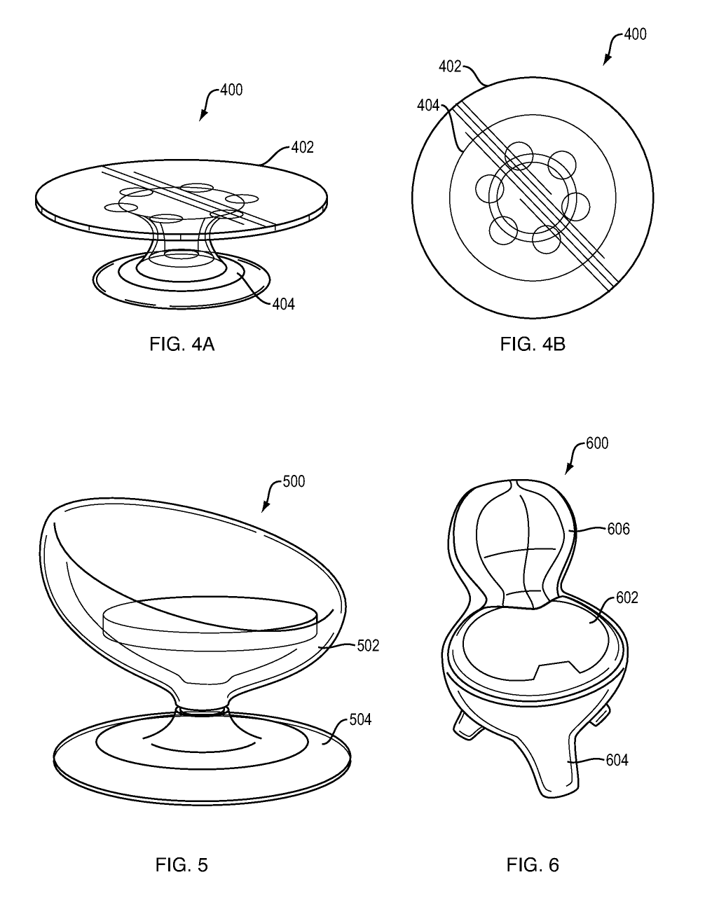

FIGS. 4A and 4B show a table 400 having a removable top 402 and a pedestal 404. Pedestal 404 is preferably substantially hollow and constructed in manner like that described above. Access for filling table 400 or drawing from the table may be provided in a manner similar to that described above.

FIG. 5 shows a chair 500 having a seat 502 supported by a pedestal 504. Seat 502 or pedestal 504 or both are preferably substantially hollow and constructed in a manner, including user access for filling and drawing, similar to that described above.

FIG. 6 shows a chair 600 having a seat 602 supported by legs 604, and a back 606. Some or all of seat 602, legs 604 and back 606 may be substantially hollow and constructed in a manner, including user access for filling and drawing, similar to that described above.

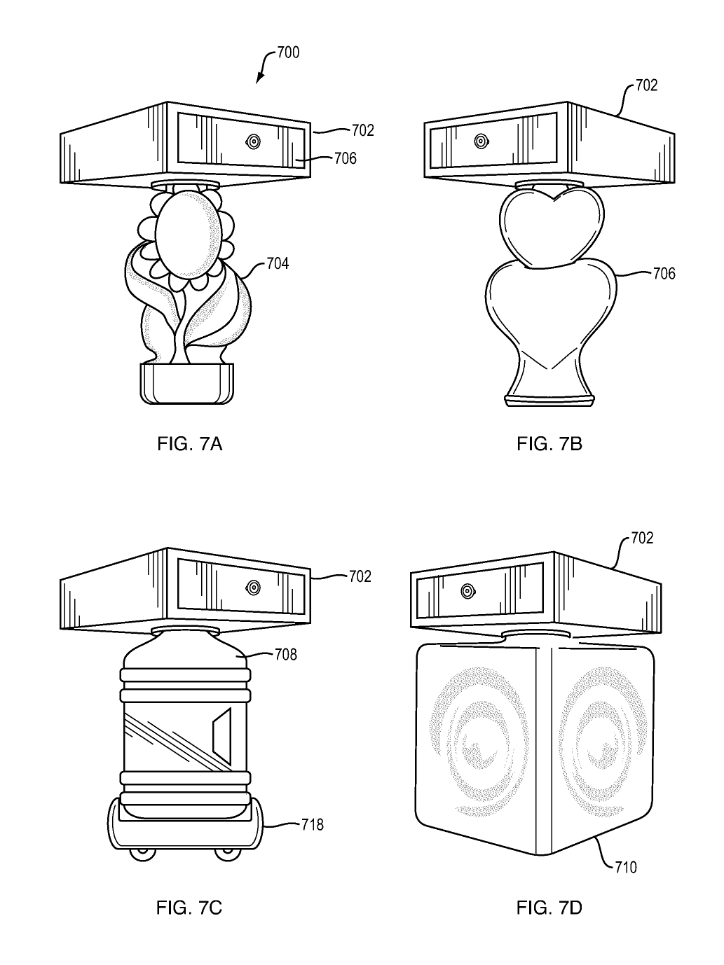

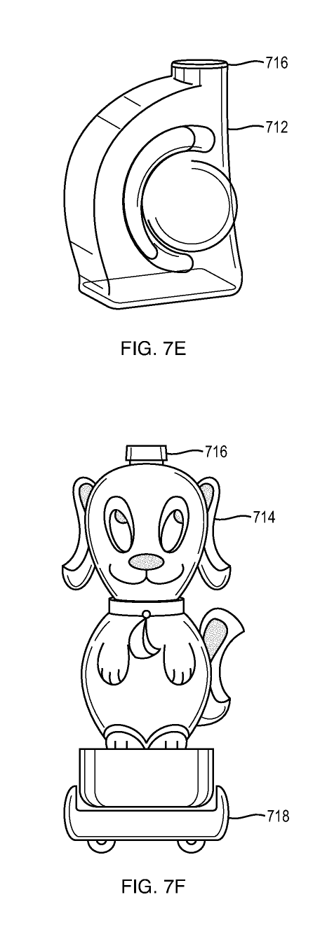

FIGS. 7A-7F show a series of end tables having hollow bases which provide integrated storage capacity for water or other material. An end table 700 has a top 702, which may include one or more drawers 706, which is supported by a base 704. Base 704 is preferably substantially hollow and liquid-tight. Bases 706, 708 and 710 provide a variety of geometries as well as varying storage capacities. As shown in FIGS. 7e and 7F, access for filling or drawing from bases 704-710, as well as bases 712 and 714, may be gained by simply removing top 702 and accessing a port 716. An optional wheeled base 718 may be used in conjunction with any of bases 704-714.

FIGS. 8A and 8B show a table 800 having a removable top 802, a bearing surface 804 on which top 802 normally rests, a pedestal 806, a port 808, a removable pump assembly 810 and a base 812. Pedestal 806 is preferably substantially hollow and constructed in a manner similar to that described above to provide integrated storage capacity for water or other material. Port 808, which may be constructed in a manner similar to that described above, provides access for filling pedestal 806 and for installing removable pump assembly 810.

In an alternative embodiment, port 808 may be located on the bottom surface of base 812. In such an embodiment, it would be necessary to invert the table to gain access to either fill or draw from the pedestal. However, top 802 would no longer need to be removable.

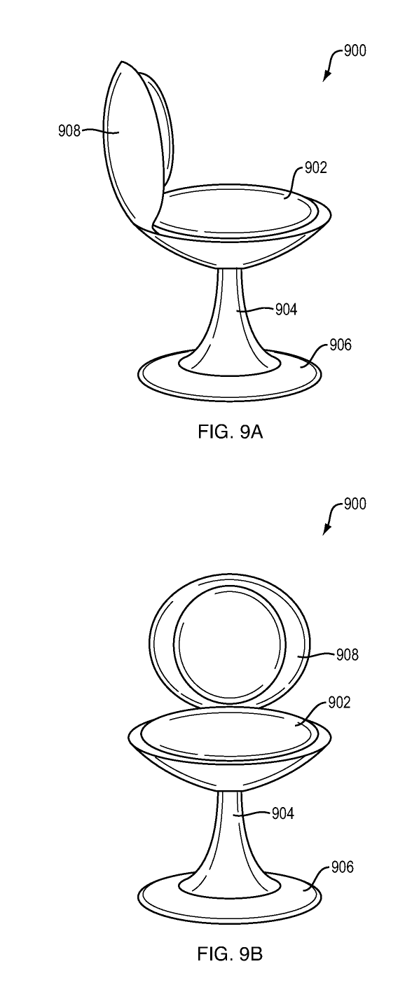

FIGS. 9A and 9B show a chair 900 having a removable seat 902, a pedestal 904, a base 906 and a back 908. When seat 902 is removed, a user would gain access to port (not shown) like port 808 in order to fill or draw from pedestal 904 which is preferably substantially hollow. A removable pump assembly like assembly 810 may be used to draw from pedestal 904.

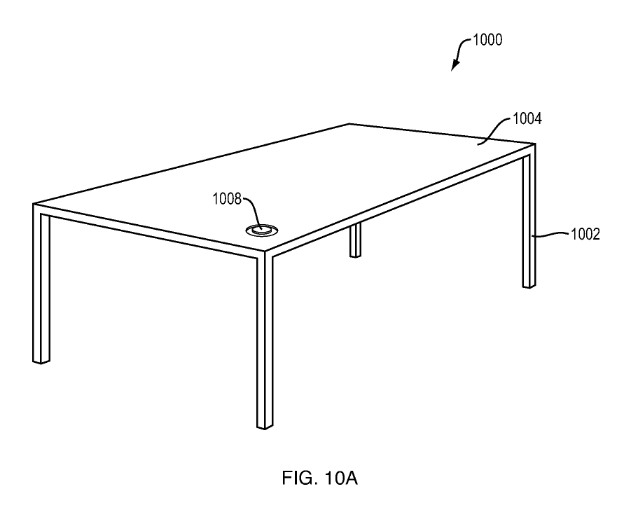

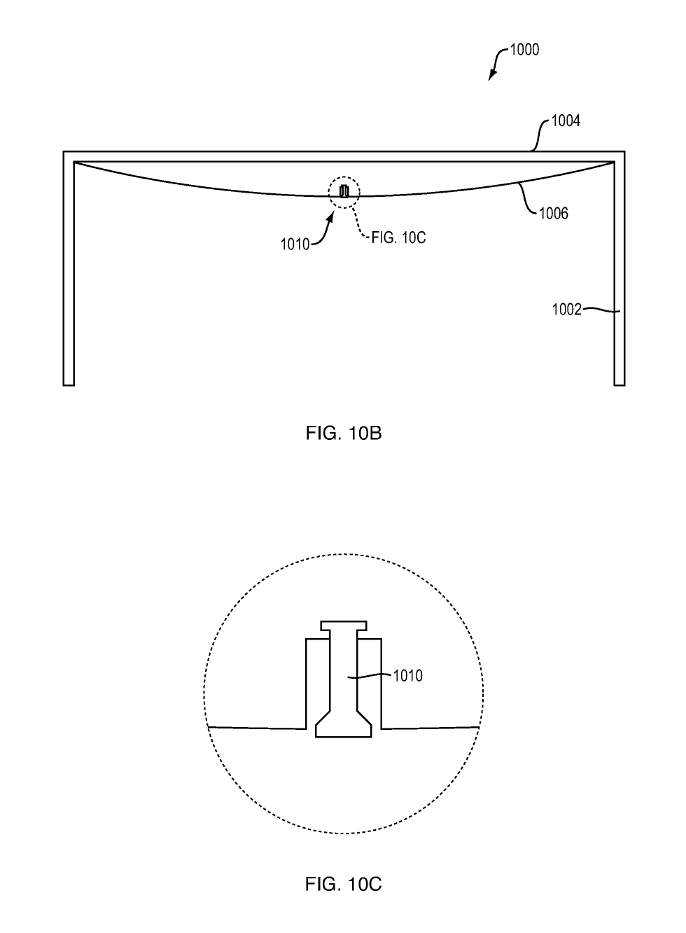

FIGS. 10A and 10B show a table 1000 having integrated storage capacity for water or other material. Table frame 1002 supports a top 1004 as well as a storage volume 1006 which is disposed beneath top 1004 and attached to frame 1002 or top 1004 or both. Access for filling or drawing from storage volume 1006 is provided by a port 1008 located near one corner of top 1004 but which may be located elsewhere for convenience. Additional access for filling or drawing from storage volume 1006 is provided by a valve 1010 which is preferably located at or near the lowest point of storage volume 1006. Valve 1010 may be implemented with any of a variety of structures including a screw cap, snap cap, push button valve and the like.

Storage volume 1006 may be constructed in a variety of ways including a bladder, a saucer, an inverted pyramid or other structure each of which is substantially hollow and liquid-tight. Storage volume 1006 may be shaped and dimensioned such that even when full it is substantially hidden when viewing table 1000 from above as shown in FIG. 10A.

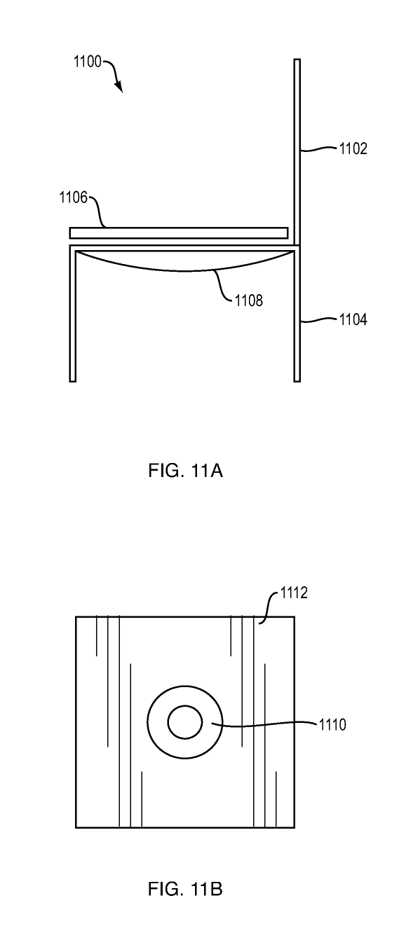

FIGS. 11A and 11B show a chair 1100 having integrated storage capacity for water or other material. Chair 1100 has a back 1102, legs 1104, a removable seat cushion 1106 and a storage volume 1108 disposed beneath seat surface 1112. Storage volume 1108 is preferably constructed in a manner similar to that described above with respect to storage volume 1006. When seat cushion 1106 is removed, access for filling or drawing from storage volume 1108 is provided by way of a port 1110.

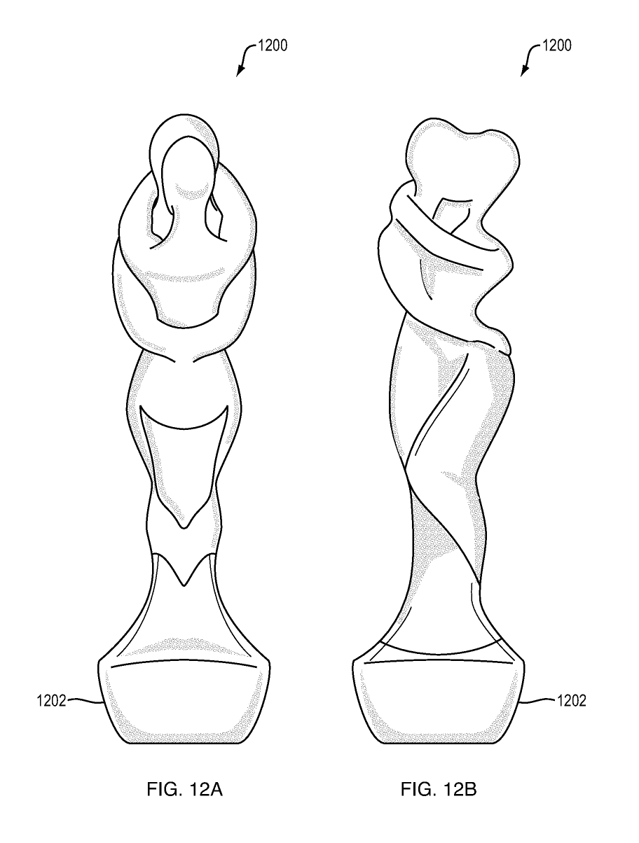

FIGS. 12A and 12B show a sculpture 1200 having integrated storage capacity for water or other material. Sculpture 1200 is preferably substantially hollow, liquid-tight and constructed of a material that is safe for storing water or other material that is intended for human consumption. A port (not shown) for filling and drawing may be located on a bottom surface of a base 1202.

The hollow structures and storage volumes described above may also be adapted to include a mechanism for automatically releasing a purifying chemical or a mechanism to provide a visual reminder to a user to replenish a purifying chemical or take other action. As an alternative to storing water, the hollow structures and storage volumes described above may be used to store other liquids, powders, grains or other objects.

What is claimed is:

1. A chair having integrated storage capacity comprising:
a substantially hollow liquid-tight structure which provides a seat and an integrated storage capacity for storing a supply of water or other material that is intended for human consumption, said structure including a port for filling and drawing; and
a base supporting said structure above a floor.

2. The chair as in claim 1 wherein said chair is bench type.

3. The chair as in claim 1 wherein said chair is lounge type.

4. The chair as in claim 1 wherein said base comprises a pedestal.

5. The chair as in claim 1 wherein said pedestal is substantially hollow and provides additional integrated storage capacity.

6. The chair as in claim 1 wherein said base comprises a plurality of legs.

7. A lamp comprising:
a substantially hollow liquid-tight globe for storing a supply of water or other material that is intended for human consumption, said globe including a port for filling and drawing; and
a base which supports said globe and has an illumination element for illuminating said globe.

8. A table having integrated storage capacity comprising:
a removable top; and
a substantially hollow liquid-tight base which supports said removable top and provides integrated storage capacity for storing a supply of water or other material that is intended for human consumption, said pedestal including a port for filling and drawing.

9. The table as in claim 8 wherein said base comprises a pedestal.

10. The table as in claim 8 further comprising a pump assembly operable to draw from said port.

11. The table as in claim 8 wherein said port is accessible by removing said top from said base.

12. The table as in claim 8 wherein said port is accessible by inverting said base.

13. A table having integrated storage capacity comprising:
a frame;
a top supported by said frame and having a port; and
a liquid-tight storage volume disposed beneath said top and configured for filling and drawing by way of said port, said storage volume providing integrated storage capacity for storing a supply of water or other material that is intended for human consumption.

14. The table as in claim 13 wherein said storage volume includes a valve for filling or drawing.

15. The table as in claim 13 wherein said storage volume comprises a bladder.

16. The table as in claim 13 wherein said storage volume comprises a saucer-shaped structure.

17. A chair having integrated storage capacity comprising:
a seat supported by a plurality of legs and having a port; and
a liquid-tight storage volume disposed beneath said seat and configured for filling and drawing by way of said port, said storage volume providing integrated storage s capacity for storing a supply of water or other material that is intended for human consumption.

18. The chair as in claim 17 wherein said storage volume includes a valve for filling or drawing.

19. The chair as in claim 17 wherein said storage volume comprises a bladder.

20. The chair as in claim 17 wherein said storage volume comprises a saucer-shaped structure.
